(19) United States
(12) Patent Application Publication
(10) Pub. No.: US 2012/0200430 A1
(43) Pub. Date: Aug. 9, 2012

(54) METHOD AND DEVICE FOR ASSISTING A DRIVER IN FINDING A PARKING SPOT

(75) Inventor: Robert Spahl, Koeln (DE)

(73) Assignee: FORD GLOBAL TECHNOLOGIES, LLC, Dearborn, MI (US)

(21) Appl. No.: 13/362,708

(22) Filed: Jan. 31, 2012

(30) Foreign Application Priority Data
Feb. 8, 2011 (DE) 102011003772.1

(51) Int. Cl. G08G 1/14

(52) U.S. Cl. 340/932.2

(57) ABSTRACT

A vehicle seeking a parking space receives a signals transmitted from a second vehicle operating in the same area as the first vehicle. The signals indicate the locations of one or more available parking space identified by the second vehicle. The spaces may be identified on the basis of the second vehicle having just vacated a space, or on the basis of an ambient sensor carried by the second vehicle. Each parking space has assigned to it a quality measure of usability as the possible parking space for the first vehicle. The quality measure may depend on a distance or travel time from the first vehicle to the space, and/or a time elapsed since the space was identified, and/or the proximity of other vehicles searching for a parking space. A display screen shows the locations of available parking spaces, their relative quality measures, and a proposed route to reach them.

### CROSS-REFERENCE TO RELATED APPLICATIONS

This application claims foreign priority benefits under 35 U.S.C. §119(a)-(d) to DE 10 2011 003 772.1, filed Feb. 8, 2011, the disclosure of which is hereby incorporated by reference in its entirety.

### TECHNICAL FIELD

The invention relates to a method and a device for assisting a driver in finding an available parking space for a vehicle.

### BACKGROUND

It is often difficult to find an available and appropriate parking space in which to park one's motor vehicle. Searching for a possible parking requires an expenditure of fuel and the driver's time. For this reason, methods have been developed to assist the driver in searching for a parking space.

DE 10 2006 005 059 A1 has proposed a parking assistance system in which parking possibilities are detected in a detection mode and transmitted to a navigation system, and this information can be called in a selection mode. According to DE 10 2004 062 021 A1, road users determine the position and the dimensions of free parking spaces while travelling past; and the collected data are transmitted to a control center and are made available to road users who are searching for a parking space, after registration with the control center. EP 1 006 503 A2 discloses that, when a vehicle is stationary, parking space information is generated by a vehicle-side terminal. This information is compared in a control center with known data, so that it is possible to detect what proportion of parking area is occupied. According to US 2007/0040701 A1, free parking spaces, which have been identified by vehicles, are stored in a database, and when there is a free parking space in the vicinity of a geographical position of someone who is searching for a parking space, said free parking space is signaled to said person.

However, a free parking space which has been identified according to the known methods and signaled to a person searching for a parking space may often already be occupied by another vehicle when the person searching for a parking space has reached the parking space, or said parking space may prove to be unsuitable for different reasons. A person searching for a parking space will therefore often drive into an identified and signaled free parking space without success. This results in expenditure in terms of time and costs, and in addition the driver's attention is taken up to a considerable degree.

### SUMMARY

According to a disclosed embodiment, a method for assisting a driver of a first vehicle to find a possible parking space comprises receiving a signal transmitted from a second vehicle, the signal indicating a location of an available parking space identified by the second vehicle, and assigning to the available parking space a quality measure of usability as the possible parking space for the first vehicle.

The method may further comprise identifying by APS on the basis of the second vehicle determining that it has just vacated that parking space.

The method may further comprise assigning a relatively high quality measure to an available parking space identified on the basis of the second vehicle determining that it has just vacated that parking space.

The method may further comprise assigning the quality measure depending at least in part upon navigation data indicating a position of the available parking space relative to the first vehicle.

According to another disclosed embodiment, a plurality of available parking spaces are identifies, the available parking spaces are ranked in order of descending quality measure, and a route is calculated from the first vehicle to a first of the available parking spaces having a highest quality measure. The route may then subsequently proceed to a second of the available parking spaces having a next highest quality measure.

According to another disclosed embodiment, a method for assisting a driver of a first vehicle to find a possible parking space comprises receiving at the first vehicle a signal transmitted from a second vehicle, the signal indicating a location of a first available parking space identified by the second vehicle; receiving at the first vehicle a second signal transmitted from a third vehicle, the second signal indicating a location of a second available parking space identified by the third vehicle; assigning to each of the first and second available parking spaces a respective quality measure of usability as the possible parking space for the first vehicle; and advising the driver as to which of the first and second available parking spaces are assigned a higher quality measure.

According to another disclosed embodiment, apparatus for assisting a driver of a first vehicle to find a possible parking space comprises a wireless communication device receiving a signal from a second vehicle, the signal indicating a location of an available parking space identified by the second vehicle, and a computational device assigning to the available parking space a quality measure of usability as the possible parking space for the first vehicle.

The invention is explained in more detail below with reference to the drawings, in which:

### BRIEF DESCRIPTION OF THE DRAWINGS

FIG. 1 is a schematic illustration of an exemplary embodiment of apparatus on board first and second vehicles for aiding in finding parking spaces;

FIG. 2 is a simplified block diagram of an exemplary embodiment of a method for finding a parking space; and

FIG. 3 shows an example of a traffic situation with parking spaces and quality measures displayed on a display unit.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

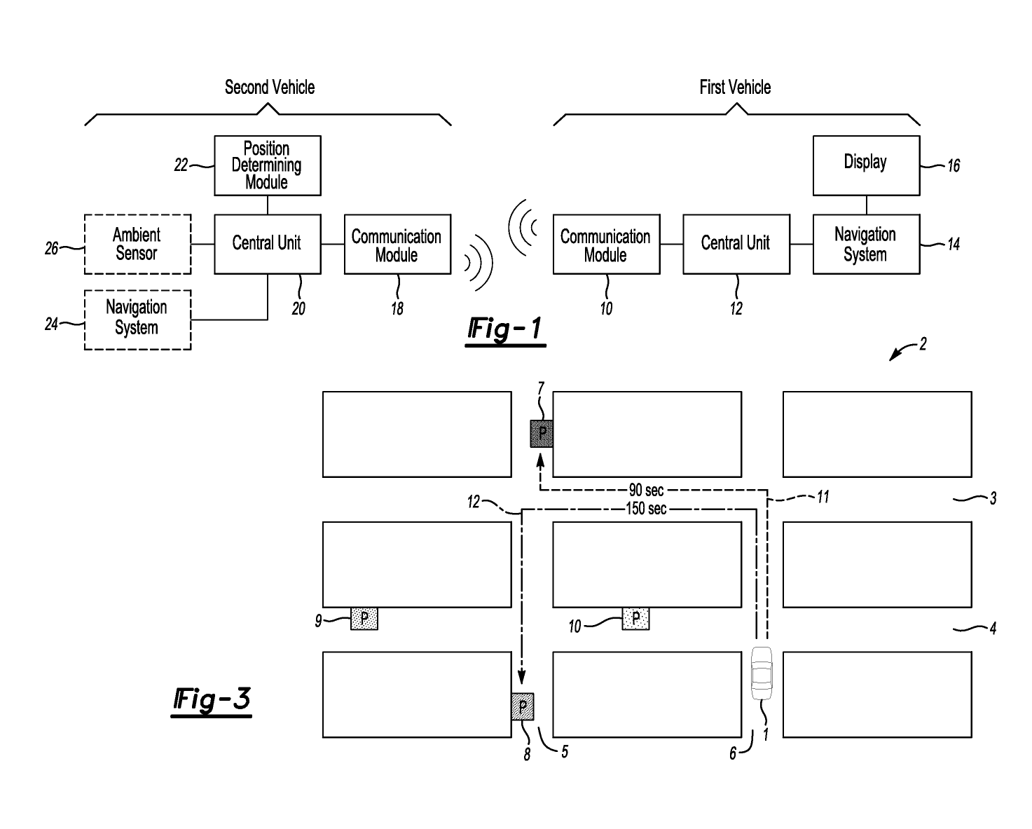

As illustrated schematically in FIG. 1, a device of a first vehicle (which is searching for a parking space) comprises a communication module 10 and a central unit 12 including a processor device and storage means. The central unit 12 is connected, for the purpose of exchanging data, to a navigation system 14 to which a display device 16 for displaying the surroundings of the vehicle is assigned. The display can take the form, for example, of a perspective view or a map.

A corresponding device of a second vehicle (which may or may not be searching for a parking space) also comprises a communication module 18 and a central unit 20. In addition, the device comprises a position determining module 22. The central unit 20 can be connected, for the purpose of exchanging data, to a navigation system 24 which can also contain the position determining module. Furthermore, the device can comprise at least one ambient sensor 26 for detecting unoccupied (free) parking spaces.

In FIG. 1, only those components of a device which are required in a first vehicle or in a second vehicle are illustrated. Since the roles can be interchanged when searching for a parking space, it is preferred that the device present in every vehicle can perform both functions and therefore respectively comprises all the modules required (not illustrated in FIG. 1).

If such a free parking space has been detected, a geographical position of the free parking space is transmitted from the second vehicle to the first vehicle. This may be the same as the position of the second vehicle at time when the free parking space is identified. The transmission may, for example, take place directly after the determination of the free parking space, or the data can be stored and only transferred after a call. The position may be determined by a satellite-based navigation system (such as GPS). The corresponding data can be transmitted, for example by a wireless “Car-to-Car” communication system, or, for example, by WLAN, Wimax, Bluetooth, SMS, or other information systems. The communication can take place directly from vehicle to vehicle or via other network users, for example infrastructure devices or control centers which collect data and, if appropriate, process said data and pass the data onto the first vehicle. The further data may be transmitted together with the transmission of the position, for example by transmitting geographical coordinates.

A quality measure of the usability as a parking possibility for the first vehicle is assigned to the free parking space that has been identified. The quality measure expresses the fact that not every identified free parking space can actually be used by the first vehicle as a parking possibility with the same probability of success. For example, the identified parking space could, for example, be occupied a short time later by another vehicle or not be suitable for parking for other reasons. The quality measure may be a quality number which is calculated on the basis of further data and which is correlated to a probability that the identified free parking space can actually be used to park by the first vehicle or indicates said probability. The quality measure can, for example, be determined by the second vehicle and be transmitted to the first together with the transmission of the position, or else be determined by the first vehicle on the basis of data which are available there.

As a result of the fact that a quality measure for the usability as a parking possibility for the first vehicle is assigned to the at least one free parking space, an improved basis for planning a further route for finding a free parking space is made available. As a result, the success rate when finding a free parking space is improved, the use of the available parking space is improved, and a large proportion of time and expense expended searching for a parking space are avoided and the driver of the first vehicle is relieved.

A free parking space may be identified by virtue of the fact that it is detected when the second vehicle itself was parked in a space and subsequently leaves that parking space. For this purpose, the freeing-up of a parking space by the second vehicle may be detected based upon the second vehicle starting its motor and/or driving away when this starting and/or driving away occurs after the second vehicle has been in a stationary state lasting for at least a predefined minimum time. To this end, the time at which a drive motor of the second vehicle is switched off may be stored and compared with the time when the drive motor is next started. If the difference between the two points in time is greater than, for example, 10 minutes, it may be concluded that the second vehicle was parked and has now driven away, and the just-vacated parking space therefore becomes free.

Alternatively or additionally, a position of the second vehicle can be determined, for example within the scope of a satellite-supported navigation system, a stationary state of the vehicle can be detected and a time period for which the vehicle was present at the respective location can be determined. It is therefore also possible to conclude that parking occurs and a used parking space is freed up. The position of the second vehicle is therefore transmitted as a position of a free parking space to the first vehicle. Through the necessity of a minimum stationary time or minimum time present, it is possible to prevent a false or incorrect indication of a free parking space such as may otherwise occur, for example, if the second vehicle was waiting at a traffic light and subsequently drove on.

A free parking space identified by the second vehicle as a result of a parking space being vacated can may, in general, be assumed to be used as a parking space by another vehicle with a relatively high probability. It is therefore, for example, generally not possible to assume that a parking space which is identified in such a way is in a zone where stopping/parking is prohibited. A free parking space which is identified in this way is therefore preferably assigned a quality measure which is high, i.e. above average, in particular a higher quality measure than free parking spaces which are identified in another way. This quality measure and/or the data necessary to determine the quality measure are transmitted from the second vehicle to the first vehicle. On the basis of this quality measure, the journey of the first vehicle can, for example, be planned in such a way that such parking spaces which have become free due to a parked vehicle driving away and which can be used with a high probability are aimed for.

Free parking spaces may also be identified by operation of one or more ambient sensors carried on board (or otherwise associated with) the second vehicle. In one possible example, sensors of a parking assistance system can be used for this. As soon as the second vehicle undershoots a minimum speed necessary for a parking assistance system to correctly identify a parking space, the lateral sensors can detect free parking spaces at the edge of the road. If such a free parking space is found, the second vehicle can be steered to this parking space manually by the driver or else by the parking assistance system, requiring, for example, braking and engagement of the reverse gear.

If no such actions to park in the identified parking space are taken by the second vehicle, the position of the free parking space may be transmitted to the first vehicle or kept ready for calling. For this purpose, the position of the second vehicle itself can be used; however, it is also frequently possible to determine the direction and the distance of the free parking space in relation to the second vehicle from the sensor data, with the result that a more precise position of the free parking space can be determined through a corresponding correction. To detect the free parking space it is also possible to use further vehicle sensors, for example one or more optical sensors, which may provide an all-round view, in the close range. In the long range it is possible to use a front-mounted optical/vision system and/or radar sensors of an automatic cruise control system (ACC), and/or sensors of other safety systems (for example Blind Spot Information System, BLIS) for this. Since free parking spaces are identified by at least one ambient sensor assigned to the second vehicle, a large number of possible parking spaces can be checked to determine whether they are free or already occupied, without the driver of the first or that of the second vehicle being tasked with this chore. This applies, in particular, when free parking spaces are identified by the ambient sensors of a multiplicity of vehicles.

When free parking spaces are identified using the at least one ambient sensor of the second vehicle, it may be possible to assume, with a relatively lower degree of certainty, that these are permissible parking spaces and not, for example, entries, private property, or other such zones where parking is prohibited. In addition, a parking space detected as being free/empty could be blocked with an object, for example, a bicycle, which has not been sensed by the ambient sensor. For this reason, free parking spaces which are identified in this way may generally be assigned a relatively low, for example below-average quality measure, in particular a lower quality measure than free parking spaces which have been identified as a result of freeing up by the second vehicle. As a result, data are made available which enable a free parking space to be aimed for, with a further increased reliability that said parking space can actually be used.

An additional level of reliability that an identified parking space is actually suitable as a parking space can be achieved by comparing the data of a navigation system, which comprise, for example, map data and/or position data about public parking spaces. If such a map database indicates that the parking space is actually a publically accessible and usable one, for example one at the edge of a road, the quality measure of the respective parking space is increased, and otherwise the quality measure is reduced. In this context it is particularly advantageous to store the positions of parking spaces at which the first vehicle has already parked once earlier, and to correspondingly supplement the data or the map of the navigation system with this prior information. By virtue of the comparison with the data of the navigation system it is possible to prevent, with increased reliability, for example, a parking space being signaled because the second vehicle has stopped because of the traffic or that a parking space which is actually unsuitable is signaled owing to inaccurate detection of the surrounding situation by one or more ambient sensors.

Furthermore, it may be advantageous, in particular when long-range sensors are used, to detect firstly whether a parking space which is marked on a map of the navigation system is in the sensor range, and only if this is the case, to activate a corresponding sensor or a sensor system and to evaluate the sensor signal to determine whether the parking space is occupied or free. This can reduce the energy consumption of such sensors and the rate of possible incorrect detection of free parking spaces.

The quality measure assigned to an identified free parking space may be dependent on data of a road sign recognition system. It is therefore possible, for example, to use a road sign recognition system to detect a prohibition on parking as indicated by corresponding road signs.

A quality measure of a free parking space, which has been identified using at least one ambient sensor of the second vehicle, can be reduced or increased accordingly; and even in the latter case the quality measure is generally lower than in the case of a free parking space which has been identified through the recent driving away of the second vehicle. When there is a free parking space, it is also advantageously possible to use a road sign recognition system in order, for example, to detect a parking prohibition which is restricted to certain times and to correspondingly increase or reduce the quality measure. In this way, a particularly reliable detection of useable parking spaces can actually be made possible.

According to embodiment of a method, the point in time at which a free parking space is identified by the second vehicle is stored and transmitted to the second vehicle. If such a point in time is not registered and transmitted, at least the point in time when the information about the free parking space is transmitted to the first vehicle can be registered. The quality measure of the free parking space is then reduced, for example reduced linearly, as a function of the time elapsed since this point in time. This allows for the fact that as the time progresses the probability that another vehicle has already occupied the parking space increases.

According to an embodiment of a method, the free parking space and the quality measure which is assigned thereto are indicated to the driver. The indication can take place, for example, optically/visually, acoustically/audibly, or haptically. In particular, a screen of a navigation system is suitable on which a map of the surroundings of the first vehicle can be displayed and on which free parking spaces at their respective position are entered for the indication. The quality measure which is assigned to each parking space can be displayed, for example, by a number or else through color or through the brightness or the contrast of the representation of a parking space symbol. The representation can be continuously adapted in accordance with a change in the quality measure, for example as a function of the time which has passed since the parking space was detected. Further information, for example a route of the first vehicle to a free parking space and/or the distance from the parking space and/or the journey time to the parking space, can also be indicated on the map. In addition, further information, for example parking garages, can be provided. As a result, the driver may be made aware of identified free parking spaces and their anticipated usability.

In addition, it is advantageous if a multiplicity of free parking spaces are identified and a route of the first vehicle to that free parking space which has, compared to other free parking spaces within a defined surrounding area or a defined circle around the current position of the first vehicle, the respective highest quality measure, is determined and indicated. In this context, the circle is defined by at least one predetermined criterion, for example the travel time or the distance to the respective parking space. This permits the closest parking space, or the parking space which can be reached most quickly and which can actually be used with a high probability, to be aimed for.

Frequently, a plurality of vehicles will be searching for a parking space at the same time. According to one embodiment of the disclosed method, when there are a multiplicity of vehicles searching for a parking space, a travel time of the first and at least of a further vehicle, or of every vehicle, which is searching for a parking space to an identified free parking space is calculated and transmitted to the other vehicles which are searching for a parking space. A quality measure which is dependent on the travel time of the respective vehicle and is respectively different when a plurality of vehicles are searching for a parking space is then assigned to this parking space. In particular, the parking space is given the highest quality measure at that vehicle which can reach this parking space in the shortest travel time. In contrast, the quality measure of the respective parking space determined by the other vehicles is reduced because when another vehicle arrives the parking space is probably already occupied by the vehicle which has the shortest travel time. In particular, the quality measure of a parking space identified by the first vehicle is lowered when the first vehicle receives the information that another vehicle can reach the respective parking space more quickly than the first. In this context it is also possible to take account of the fact that a vehicle takes only one parking space and therefore only the quality measure of the one parking space which can be reached most quickly by a vehicle is reduced for the other vehicles. This can prevent a plurality of vehicles aiming for the same free parking space simultaneously.

Apparatus for assisting a driver of a vehicle in finding a possible parking space comprises means for determining a position of the vehicle and means for wireless, in particular bidirectional communication with other vehicles as well as a processor device, wherein the device is configured to carry out the method described above. The processor device may be operative to determine free parking spaces on the basis of the information received via the communication means, to calculate a quality measure, and to actuate the communication means to transmit information about identified parking spaces. The processor device can be assigned storage means for storing data about parking spaces which have been identified or even parking spaces which have already been taken. The apparatus can be provided, in particular, for use in a first vehicle as well as in a second vehicle.

The apparatus can also comprise inputs for sensor signals, for example signals of the engine controller or of ambient sensors, as well as a timer. In addition, the apparatus itself can comprise sensors for sensing the surrounding situation for the detection of parking spaces. Furthermore, the apparatus may be connected to a navigation system in such a way that an exchange of data with the navigation system, in particular transmission of map data, is made possible, and a display device of the navigation system can be used to display the identified parking spaces and the quality measures of the parking spaces. In addition, it is advantageous to use data of the navigation system for determining positions. The apparatus can also be part of a navigation system or of a parking assistance system. The apparatus can also comprise an input element for the inputting of instructions by the driver, for example in order to indicate whether a parking space is being searched for or not, and for example within which surrounding area and within which maximum travel time a displayed parking space is to be reached.

An automatically operating apparatus relieves the driver of the burden in finding a free parking space, improves the use of the available parking space and avoids a large proportion of the journeys for finding a parking space.

According to one embodiment, the apparatus is always active when the vehicle is operating. This ensures that even when a road user is not searching for a parking space, the apparatus which is present in the respective vehicle nevertheless detects free parking spaces and transmits them to further vehicles. As a result, the number of the free parking spaces which are known to the further vehicles is increased and the finding of a usable parking space is made easier for these vehicles.

The apparatus disclosed herein can be permanently connected to the vehicle, which may be advantageous, for example, in the case of integration into an assistance system. The apparatus may also be independent of the vehicle and can be embodied as a portable communication device, in particular as a smartphone, laptop or tablet computer, with a corresponding application program (App). As a result, particularly widespread coverage can be achieved so that a particularly large number of free parking spaces is identified and transmitted to a first vehicle. In addition, for example smartphones generally already contain the necessary means for determining position and for communicating with other smartphones.

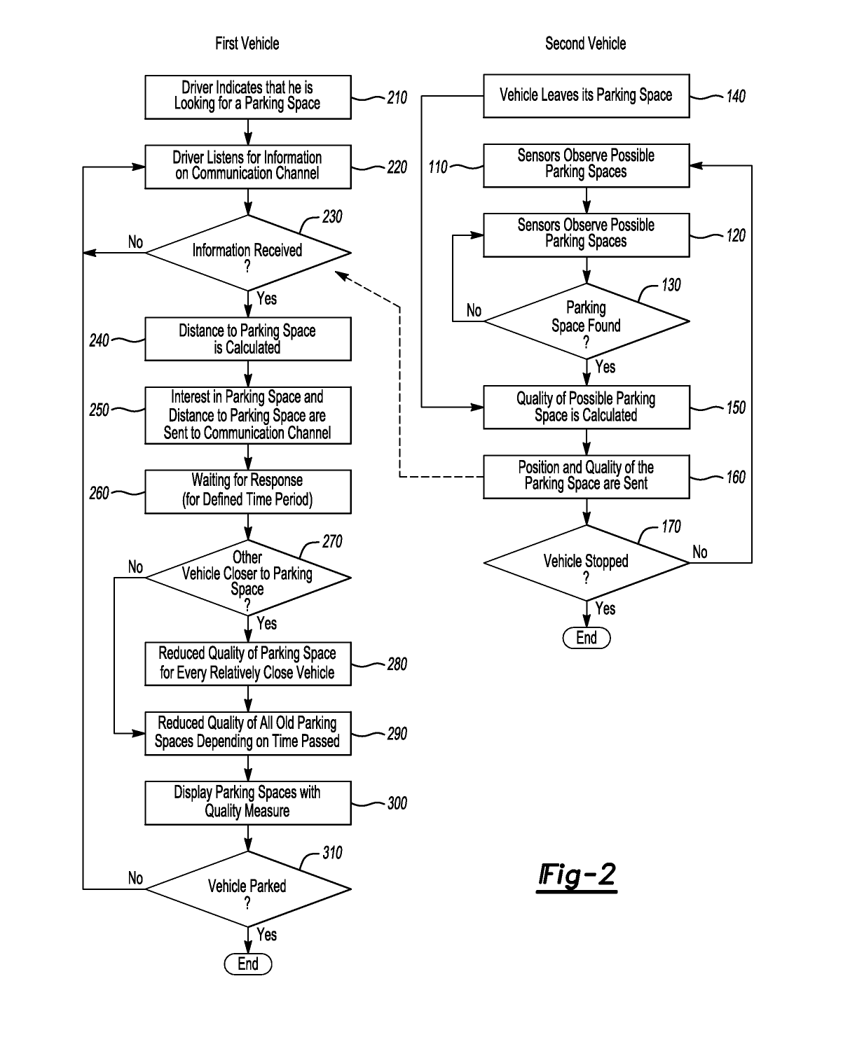

In the method illustrated in simplified form in FIG. 2, it is assumed that a first vehicle is searching for a parking space (left-hand side of page) while a second vehicle is not searching for a parking space (right-hand side of page), but is travelling in the same area and, if appropriate, detects an available or free parking space. In this context, a free parking space can be detected by ambient sensors of the second vehicle (blocks 110-130) or by the second vehicle exiting a parking space (block 140).

A free or available parking space can be a parking space which is arranged transversely or longitudinally with respect to a road, between two parked vehicles, between a parked vehicle and an obstacle or between two obstacles. Such a free parking space can, however, also be a parking space which is divided by markings on the ground or is defined in some other way and is not occupied by another vehicle, or else is a free, unmarked peripheral area of a road.

Depending on the way in which the free parking space was detected, and, if appropriate, while using further information, a quality level, i.e. a quality measure of the parking space, is calculated (block 150). The further information may be, for example, map data of a navigation system, sensor data of ambient sensors which permit the reliability of the detection of the parking space to be estimated, or further sensor data, for example signals of a road sign recognition system. A message or notification that a free parking space has been identified is sent, along with the position and quality of the parking space, to other vehicles (block 160). As long as the second vehicle is operating and moving (block 170, “YES”), free parking spaces are identified automatically and transmitted to other vehicles. When the second vehicle stops (block 170, “NO”), no further detection of free parking spaces takes place.

When the driver of the first vehicle indicates, by means of an input element, that he/she is searching for an available and appropriate parking space (block 210) or the vehicle detects a parking request as indicated by the driving behavior or driving history, the vehicle is ready to receive. As soon as information about a free parking space, which is transmitted by another vehicle, has been received (block 230, “YES”), a spatial or chronological distance of the first vehicle to the parking space is determined (block 240). These data may be, if appropriate and if the vehicles are properly equipped, transmitted to other vehicles which are also searching for a parking space (block 250) on a common communication channel. If the first vehicle receives a response from another vehicle using the common communication channel within a predefined time period (block 260), the quality level of the parking space (as calculated in relation to the first vehicle) may be reduced depending on the number of other vehicles whose distance from the respective parking space is less (blocks 270 and 280). The quality level of the parking space and that of the parking spaces which have already been transmitted may also be reduced depending on the time which has passed since the detection of the parking spaces or the transmission of the respective messages (block 290).

The detected available parking spaces are communicated to the driver of the first vehicle together with their respective quality level (block 300). If a free parking space has been taken by the first vehicle, the information that this parking space has been occupied is sent (block 310) and the method is ended.

As is illustrated schematically in FIG. 3, the information about free parking spaces can be displayed, together with an evaluation of the quality level, in an intuitively comprehensible form, for example on a map of the surroundings 2 of the vehicle 1, to the driver of a vehicle 1 which is searching for a parking space. Roads 3, 4, 5, 6 are displayed on the map. Parking spaces 7, 8, 9, 10 which have been detected by one or more other vehicles (not shown in FIG. 3) which are not searching for a parking space are respectively located at the edge of the road. In this context, data have been transmitted from the one or more other vehicles to the vehicle 1, said data indicating the positions of the parking spaces 7, 8, 9, 10 and permitting the respective quality measures to be determined. Vehicle 1 receives these data and calculates the respective quality measures.

The parking spaces 7, 8, 9, 10 are displayed in a positionally correct fashion by a symbol or icon along with an indication of their respective assigned quality measures. It is therefore possible, for example, for a high quality measure to be displayed by a symbol in a high degree of contrast and for a low quality measure to be displayed by an icon in a low degree of contrast, as indicated in FIG. 3. In a possible alternative to this contrast method, a color method may be used in which a high quality level is displayed, for example, in green, and the display changes via yellow to red as the quality measure drops. A change in the display of the quality level of a parking space can take place continuously in accordance with the decreasing quality measure as the time progresses since the parking space was detected, and/or any other change of condition that affects the quality of an available parking space.

Then, a route to that parking space 7 having the highest quality measure within the surroundings 2 of the vehicle 1 is calculated and displayed. In addition, routes to further parking spaces can be calculated and displayed, for example a route 12 to the parking space 8 with the second highest quality level. A route to a parking space 10 with an even lower quality level is not displayed even though this parking space 10 is closer to the current position of the vehicle 1. In addition to the routes it is possible, for example, to indicate the travel time which is expected to be required to reach the parking space, 90 sec or 150 sec in the example shown (route 11 or 12).

If a plurality of vehicles searching for a parking space are travelling in the respective area simultaneously, it is therefore possible, for example, for the parking space 7 to be given a high quality level in relation to only one of those searching vehicle, in particular to the vehicle with the shortest travel time to this parking space, and for said quality level to be correspondingly displayed. The same parking space 7 is therefore given a lower quality level in relation to the other vehicles and is displayed to those vehicles with the relatively lower quality level. The available parking spaces in an area are therefore automatically apportioned among the vehicles searching for a parking space in the area.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for assisting a driver of a first vehicle to find a possible parking space comprising:
receiving at the first vehicle a signal transmitted from a second vehicle, the signal indicating a location of an available parking space identified by the second vehicle; and
assigning to the available parking space a quality measure of usability as the possible parking space for the first vehicle.

2. The method of claim 1 wherein the available parking space is identified by the second vehicle on the basis of the second vehicle determining that it has just vacated the available parking space.

3. The method of claim 2 wherein the determination that the second vehicle has just vacated the available parking space is made based on the second vehicle being started after being stationary for a predefined minimum time.

4. The method of claim 2 wherein a high quality measure is assigned to the available parking space identified in such a way.

5. The method of claim 1 wherein the available parking space is identified by operating an ambient sensor carried by the second vehicle.

6. The method of claim 1 wherein the quality measure assigned to the available parking space depends at least in part upon navigation data indicating a position of the available parking space relative to the first vehicle.

7. The method of claim 1 wherein the quality measure assigned to the available parking space depends at least in part upon a signal of a road sign detection system.

8. The method of claim 1 wherein the quality measure of the available parking space is reduced as a function of an elapsed time which has passed since a time at which the available parking space is identified.

9. The method of claim 1 further comprising communicating to the driver of the first vehicle at least one of the location of the available parking space and the quality measure assigned thereto.

10. The method of claim 1 further comprising:
identifying a plurality of available parking spaces;
ranking the plurality of available parking spaces in order of descending quality measure; and
calculating a route of the first vehicle to a first of the available parking spaces having a highest quality measure and subsequently to a second of the available parking spaces having a next highest quality measure.

11. The method of claim 1 further comprising:
receiving at the first vehicle a second signal transmitted from a further vehicle searching for an available parking space, the second signal indicating a location of a second available parking space identified by the further vehicle.

12. A method for assisting a driver of a first vehicle to find a possible parking space comprising:
receiving at the first vehicle a signal transmitted from a second vehicle, the signal indicating a location of a first available parking space identified by the second vehicle;
receiving at the first vehicle a second signal transmitted from a third vehicle, the second signal indicating a location of a second available parking space identified by the third vehicle;
assigning to each of the first and second available parking spaces a respective quality measure of usability as the possible parking space for the first vehicle; and
advising the driver as to which of the first and second available parking spaces are assigned a higher quality measure.

13. The method of claim 12 wherein the quality measure assigned to at least one of the available spaces is based at least in part upon a comparison of a first travel time of the first vehicle to the at least one available parking space and a second travel time of the second vehicle to the at least one available parking space.

14. Apparatus for assisting a driver of a first vehicle to find a possible parking space comprising:
a wireless communication device receiving a signal from a second vehicle, the signal indicating a location of an available parking space identified by the second vehicle; and
a computational device assigning to the available parking space a quality measure of usability as the possible parking space for the first vehicle.

15. The apparatus of claim 14 further comprising a navigation system determining a position of the first vehicle.

16. The apparatus of claim 15 wherein the computational device calculates a route from the first vehicle to the available parking space.

17. The apparatus of claim 14 further comprising a display unit providing a visual indication of the location of the available parking space.

18. The apparatus of claim 14 wherein the apparatus is embodied as a portable communication device.

19. The apparatus of claim 14 wherein the wireless communication device further receives a signal from a road sign detection system, and the quality measure assigned to the available parking space is based at least in part upon a status of the available parking space as indicated by a road sign.

20. The apparatus of claim 14 wherein the wireless communication device receives signals from a plurality of vehicles indicating a plurality of available parking spaces, and the computational device assigns a respective quality measure to each of the plurality of available parking spaces.
